(19) United States
(12) Patent Application Publication
(10) Pub. No.: US 2026/0101396 A1
(43) Pub. Date: Apr. 9, 2026

(54) METHODS, ARCHITECTURES, APPARATUSES AND SYSTEMS FOR NON 3GPP DATA PLANE CONFIGURATION BASED ON ENERGY RELATED INFORMATION

(71) Applicant: InterDigital Patent Holdings, Inc., Wilmington, DE (US)

(72) Inventors: Michael STARSINIC, Newtown, PA (US); Achref Methenni, Montreal (CA); Saad Ahmad, Montreal (CA); Rocco Di Girolamo, Laval (CA); Samir Ferdi, Kirkland (CA)

(21) Appl. No.: 18/905,558

(22) Filed: Oct. 3, 2024

(51) Int. Cl. H04W 76/15; H04W 48/16; H04W 48/20; H04W 60/04

(52) U.S. Cl. CPC H04W 76/15; H04W 48/16; H04W 48/20; H04W 60/04

(57) ABSTRACT

A method, implemented in a WTRU is described herein. The method may include (i) receiving energy information associated with a plurality of gateways, (ii) selecting a first gateway from the plurality of gateways based on the energy information, (iii) connecting to the first gateway, (iv) sending a first request message for establishing a first connection, the first request message being associated with the first gateway, (v) receiving a response message indicating that a second gateway may be to be selected by the WTRU from the plurality of gateways, the response message indicating one or more gateways of the plurality of gateways to not be used for selecting the second gateway, (vi) selecting the second gateway based on the response message and the energy information, (vii) connecting to the second gateway and (viii) sending a second request message for establishing a second connection.

### TECHNICAL FIELD

The present disclosure is generally directed to the fields of communications, software and encoding, including methods, architectures, apparatuses, and systems directed to non-third generation partnership project (3GPP) data plane configuration based on energy related information.

### BACKGROUND

3GPP technical report (TR) 23.700-66, “Study on Energy Efficiency and Energy Saving”, V19.0.0 describes enhancements to the 5G system with a goal of improving the energy efficiency of the 5G System. A wireless transmit/receive unit (WTRU) may connect to the 5G system via a non 3GPP access. Embodiments described herein have been designed with the foregoing in mind.

### SUMMARY

Methods, architectures, apparatuses, and systems directed to non-3GPP data plane configuration based on energy related information are described herein. In an embodiment, a wireless transmit/receive unit (WTRU) is described. The WTRU may include circuitry including any of transmitter, a receiver, a processor, and a memory. The WTRU may be configured to receive energy information associated with a plurality of gateway network elements. The WTRU may be configured to select a first gateway network element from the plurality of gateway network elements based on the energy information and to connect to the first gateway network element. The WTRU may be configured to send a first request message directed to a network element of a cellular network for establishing a first connection, the first request message being associated with the first gateway network element. The WTRU may be configured to receive a response message from the network element of the cellular network, the response message indicating that a second gateway network element may be to be selected by the WTRU from the plurality of gateway network elements. In various embodiments, the response message may further indicate one or more gateway network elements of the plurality of gateway network elements to not be used for selecting the second gateway network element. The WTRU may be configured to select the second gateway network element from the plurality of gateway network elements based on the response message and the energy information. The WTRU may be configured to connect to the second gateway network element and to send a second request message to the network element of the cellular network for establishing a second connection.

In an embodiment, a method implemented in a WTRU is described. The method may include receiving energy information associated with a plurality of gateway network elements and selecting a first gateway network element from the plurality of gateway network elements based on the energy information. The method may include connecting to the first gateway network element. and sending a first request message directed to a network element of a cellular network for establishing a first connection, the first request message being associated with the first gateway network element. The method may include receiving a response message from the network element of the cellular network, the response message indicating that a second gateway network element may be to be selected by the WTRU from the plurality of gateway network elements. In various embodiments, the response message may further indicate one or more gateway network elements of the plurality of gateway network elements to not be used for selecting the second gateway network element. The method may include selecting the second gateway network element from the plurality of gateway network elements based on the response message and the energy information. The method may include connecting to the second gateway network element and sending a second request message to the network element of the cellular network for establishing a second connection.

In an embodiment, a network element of a cellular network is described. The network element may include circuitry including any of transmitter, a receiver, a processor, and a memory. The network element may be configured to receive a request message associated with a gateway network element for establishing a connection with a WTRU, the request message including requested network slice information. The network element may be configured to send a recommendation request to an energy efficiency control function of the cellular network, the recommendation request comprising the requested network slice information and identity information indicating an identity of the gateway network element. The network element may be configured to receive a recommendation response from the energy efficiency control function of the cellular network, the recommendation response indicating one or more gateway network elements to not be used in a gateway network element reselection. The network element may be configured to send a response message based on the recommendation response, the response message indicating that a selection of another gateway network element may be to be performed by the WTRU.

In an embodiment, a method implemented in a network element is described. The method may include receiving a request message associated with a gateway network element for establishing a connection with a WTRU, the request message including requested network slice information. The method may include sending a recommendation request to an energy efficiency control function of the cellular network, the recommendation request comprising the requested network slice information and identity information indicating an identity of the gateway network element. The method may include receiving a recommendation response from the energy efficiency control function of the cellular network, the recommendation response indicating one or more gateway network elements to not be used in a gateway network element reselection. The method may include sending a response message based on the recommendation response, the response message indicating that a selection of another gateway network element may be to be performed by the WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example procedure for performing non-3GPP gateway selection based on energy information;

FIG. 3 is a diagram illustrating an example procedure for a WTRU to perform data plane gateway selection based on energy information;

FIG. 4 is a diagram illustrating an example method for non-3GPP data plane configuration based on energy information, implemented in a WTRU; and

FIG. 5 is a diagram illustrating an example method for non-3GPP data plane configuration based on energy information, implemented in a network element.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

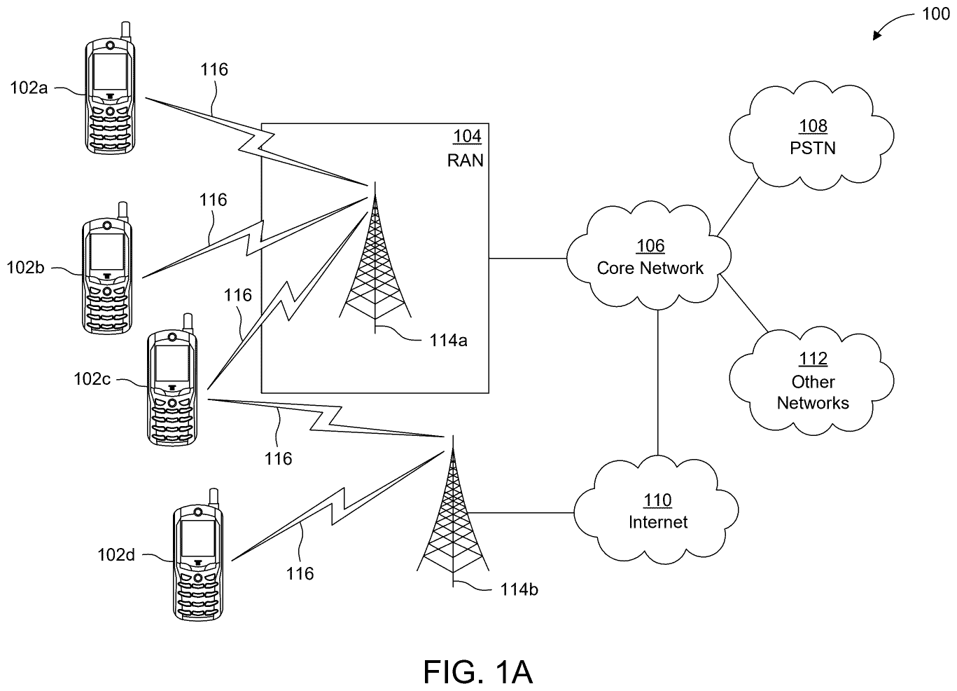

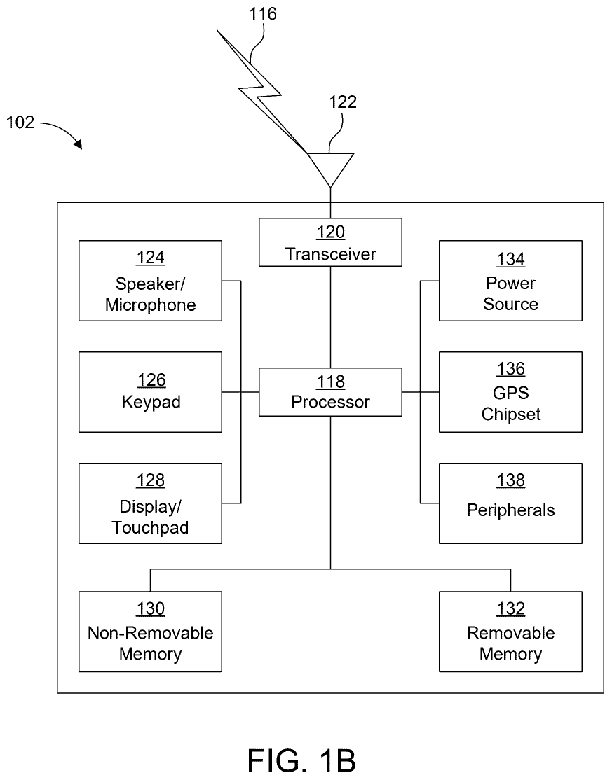

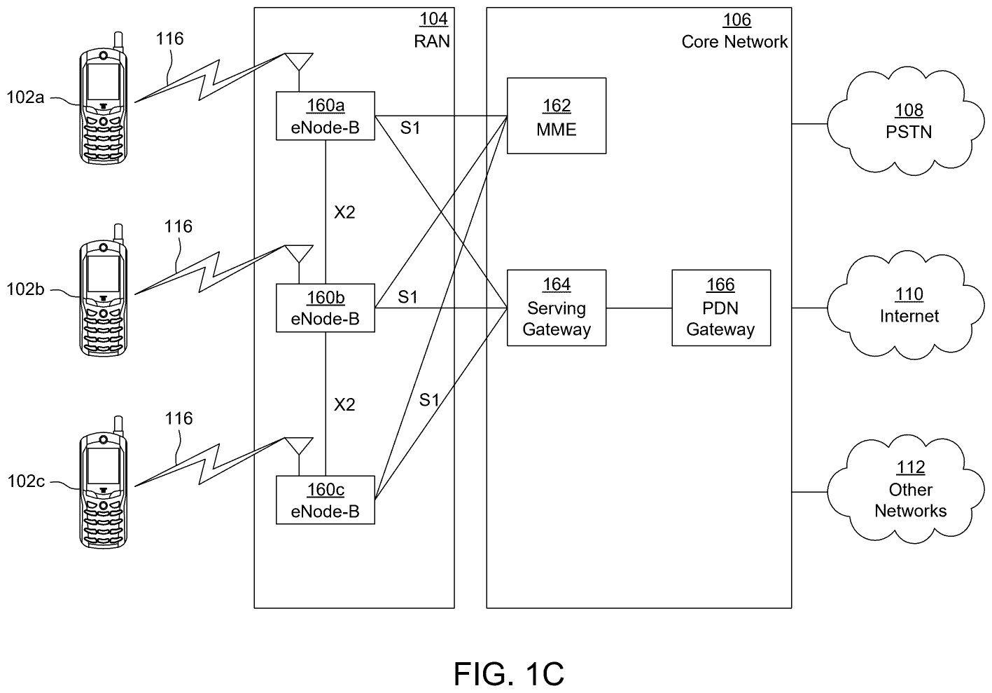

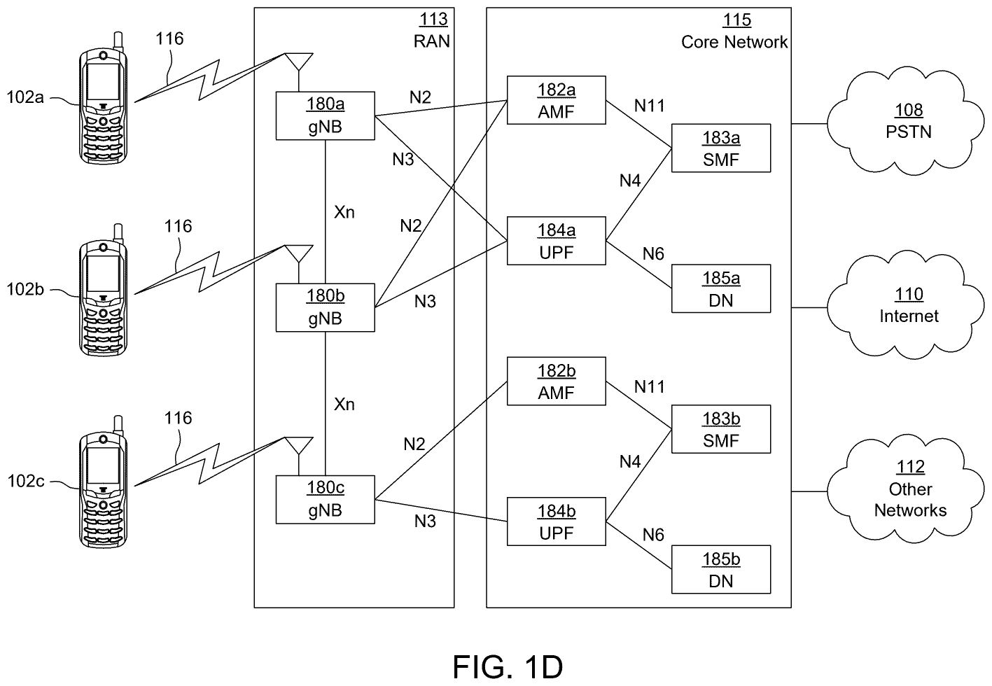

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B”may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

### Terminology

Embodiments described herein describe how an energy efficiency control function (EECF) can provide guidance information to an AMF about what non 3GPP interworking function(s) (N3IWF(s)) or trusted non-3GPP gateway function(s) TNGF a WTRU may be recommended to use or may not be recommended to use. In another example, a network data analytics function (NWDAF) may provide the same guidance information to the AMF.

Embodiments are described herein with the example of an N3IWF network element or a TNGF network element (collectively N3IWF/TNGF). Embodiments described herein are not limited to N3IWF/TNGF network elements and may be applicable to any kind of gateway network element running any kind of network function, such as e.g., a gateway to a 6G core network or an interworking function to a 6G core network.

Embodiments are described herein with the example of an EECF for providing guidance information relative to energy information. Embodiments described herein are not limited to an EECF and may be applicable to any kind of network element running any kind of network function, such as e.g., a NWDAF.

In embodiments described herein, a single network slice selection assistance information (S-NSSAI) may identify a type of slice. Network slice instance (NSI) identifier (ID) may identify a network slice instance. An S-NSSAI may be associated with multiple NSI IDs.

In embodiments described herein, messages that may be sent between the WTRU and the AMF may be non-access stratum mobility management (NAS-MM) messages.

In embodiments described herein, messages that may be sent between the WTRU and the SMF may be access stratum mobility session (NAS-SM) messages.

In embodiments described herein, a data plane gateway may serve as a security gateway between the WTRU and the network (such as e.g., the UPF). An evolved packet data gateway (ePDG) may be considered as a type (e.g., example) of data plane gateway. A TNGF/N3IWF may also be considered a type (e.g., example) of data plane gateway.

In embodiments described herein, a registration (e.g., registration request/response messages) may involve at least establishing a NAS connection with an AMF.

In embodiments described herein, a PDU session establishment (e.g., request/response/accept/reject messages) may involve at least a connection with a data plane gateway (such as e.g., an UPF).

Embodiments are described herein with a N3IWF/TNGF and a data plane gateway as examples of gateway network elements for connecting to a WTRU. Embodiments are not limited to any of a N3IWF gateway, a TNGF gateway and a data plane gateway and are applicable to any kind of gateway network elements for connecting to a WTRU.

Embodiments are described herein with an AMF and an SMF as examples of infrastructure network elements of a cellular network communicating with a WTRU relative to energy based non 3GPP data plane configuration. Embodiments are not limited to any of an AMF and an SMF and are applicable to any kind of (e.g., infrastructure-based) network elements of the cellular network.

Embodiments are described herein with a registration request and a PDU session establishment request as examples of request messages sent by a WTRU for establishing a connection. Embodiments are not limited to any of registration request message and a PDU session establishment request message and are applicable to any kind of request messages that may be sent by a WTRU for establishing a connection.

Embodiments are described herein with a registration accept/reject and a PDU session establishment accept as examples of response messages received by a WTRU for completing a connection establishment. Embodiments are not limited to any of registration accept/reject and a PDU session establishment accept messages and are applicable to any kind of response messages that may be received by a WTRU for completing a connection establishment.

### Overview of TNGF/N3IWF Selection Method in a WTRU

In an example, a WTRU may receive (e.g., energy information indicating) one or more sets of energy metrics and associated N3IWF/TNGF identifiers. For example, the energy information may (e.g., also) be associated with a data network name (DNN)/S-NSSAI combination. For example, the energy information may (e.g., also) be associated with location information.

In an example, the WTRU may perform an N3IWF/TNGF selection procedure based on the energy metrics. The result of the selection procedure may include the determination (e.g., selection) of a N3IWF/TNGF. For example, the selection procedure may (e.g., also) be based on the types of network slices (S-NSSAI's) that the WTRU may intend on connecting to.

In an example, the WTRU may connect to the identified (e.g., determined, selected) N3IWF/TNGF.

In an example, the WTRU may send a registration request message to an AMF via the selected N3IWF/TNGF.

In an example, the WTRU may receive a registration reject message from the AMF. The registration reject message may indicate that the WTRU may perform a new N3IWF/TNGF selection procedure. The registration reject message may further indicate the identities of one or more N3IWF(s)/TNGF(s) that the WTRU may not consider in the N3IWF/TNGF selection procedure.

In an example, the WTRU may initiate a second N3IWF/TNGF selection procedure based on the information included in the registration reject message.

### Overview of TNGF/N3IWF Selection Method in an AMF

The TNGF/N3IWF selection method is described with an AMF as an example of network element of a cellular network. The TNGF/N3IWF selection method described herein is not limited to an AMF and may be applicable to any kind of network element of the cellular network (such as e.g. a network function performing a mobility management procedure).

In an example, the AMF may receive an N2 message from an N3IWF/TNGF. The N2 message may include WTRU location information. The N2 message may further include a registration request from the WTRU. The registration request may include (e.g., indicate) a requested NSSAI.

In an example, the AMF may send a recommendation request (e.g., message) to an EECF. The recommendation request (e.g., message) may include any of the identity of the N3IWF/TNGF, the WTRU identity, the WTRU location information, and a list (e.g., set) of slices. The list (e.g., set) of slices may include, for example, the S-NSSAI(s) that may have been included in the requested NSSAI. In another example, the list (e.g., set) of slices may include a list (e.g., set) of S-NSSAI(s) that the AMF may intend to send to the WTRU in an allowed NSSAI.

In an example, the AMF may receive a recommendation response (e.g., message) from the EECF. The recommendation response (e.g., message) may include the identity of one or more N3IWF(s)/TNGF(s) that may not be recommended to use.

In an example, the AMF may send a registration reject message to the AMF. The registration reject message may indicate that the WTRU may (e.g., be requested to) perform a new N3IWF/TNGF selection procedure. The registration reject message may further indicate the identities of one or more N3IWF(s)/TNGF(s) that the WTRU may not (e.g., may avoid to) consider in the N3IWF/TNGF selection procedure.

### Overview of Data Plane Gateway Selection Method in a WTRU

In an example, a WTRU may receive (e.g., energy information indicating) one or more sets of energy metrics and associated data plane gateway identifiers. For example, the energy information may (e.g., also) be associated with a DNN/S-NSSAI combination. For example, the energy information may (e.g., also) be associated with location information.

In an example, the WTRU may perform a data plane gateway selection procedure based on the energy metrics. The result of the selection procedure may include the determination (e.g., selection) of the data plane gateway. For example, the selection procedure may (e.g., also) be based on the types of network slices (S-NSSAI's) that the WTRU may intend on connecting to. In an example, the WTRU may connect to the identified (e.g., determined, selected) data plane gateway.

In an example, the WTRU may send a PDU session establishment request (e.g., message) to an SMF. The PDU session establishment request message may include, for example, the identity of the data plane gateway.

In an example, the WTRU may receive a PDU session establishment accept message from the SMF. The PDU session establishment accept message may indicate that the WTRU may (e.g., be requested to) perform a new data plane gateway selection procedure. The PDU session establishment accept message may include the identities of one or more data plane gateway(s) that the WTRU may (e.g., be requested to) not consider in the data plane gateway selection procedure.

In an example, the WTRU may initiate a second data plane gateway selection procedure based on the information in the PDU session establishment accept message.

### Overview of Data Plane Gateway Selection Method in an SMF

The data plane gateway selection method is described with an SMF as an example of network element of the cellular network. The data plane gateway selection method described herein is not limited to an SMF and may be applicable to any kind of network element of the cellular network (such as e.g. a network function performing a session management procedure).

In an example, the SMF may receive a PDU session establishment request (e.g., message) from a WTRU (e.g., via the AMF) The PDU session establishment request (e.g., message) may include, for example, the identity of the data plane gateway.

In an example, the SMF may send a recommendation request (e.g., message) to an EECF. The recommendation request (e.g., message) may include (e.g., indicate) any of the identity of the data plane gateway, the WTRU identity, the WTRU location information, and the DNN/S-NSSAI combination that may be associated with the PDU session establishment request.

In an example, the SMF may receive a recommendation response (e.g., message) from the EECF. The recommendation response (e.g., message) may include any of the identity of a data plane gateway and an UPF identifier.

In an example, the SMF may configure the UPF that may be associated with the UPF identifier to be the PDU session anchor (PSA) of the PDU session.

In an example, the SMF may send a PDU session establishment accept message to the WTRU (e.g., via the AMF) The PDU session establishment accept message may indicate that the WTRU may (e.g., be requested to) perform a new data plane gateway selection procedure. The PDU session establishment accept message may include the identities of one or more data plane gateway(s) that the WTRU may (e.g., be requested to) not consider in the data plane gateway selection procedure.

### Example of N3IWF Selection in the 5G System

In the 5G system, a WTRU may be configured with any of (i) an N3IWF identifier configuration which may include any of a fully qualified domain name (FQDN) and an internet protocol (IP) address of the N3IWF in the home public land mobile network (HPLMN), and (ii) an extended home N3IWF identifier configuration which may include one or more tuples of FQDN/IP address of the N3IWF in the HPLMN and the S-NSSAIs supported by this N3IWF.

In an example, the WTRU may use the configured information to select an N3IWF identifier. In another example, the WTRU may construct (e.g., determine) an N3IWF identifier based on the tracking area where the WTRU may currently be located.

3GPP TS 23.502 “Procedures for the 5G System (5GS); Stage 2”, V18.6.0, clause 4.12.2.2 describes that, when a WTRU attempts to register with the 5GC via an N3IWF, the AMF may reject the registration attempt, and the AMF may provide target N3IWF information (FQDN and/or IP address) to the WTRU within the registration reject message. For example, the AMF may determine that the WTRU-selected N3IWF may not be appropriate for the requested slices that the WTRU may be allowed to access to.

### Example of TNGF Selection in the 5G System

In the 5G system, a WTRU may be configured with a trusted non-3GPP access network (TNAN) list that may include any of a TNGF ID, a list of supported S-NSSAI, and a service set identifier (SSID) list. The S-NSSAI list may indicate the list of S-NSSAI(s) that may be supported by the indicated TNGF. The SSID list may indicate the list of SSID(s) through which the indicated TNGF can be reached.

In an example, the WTRU may use the configured information to select an TNGF identifier. In another example, the WTRU may construct (e.g., determine) an TNGF identifier based on the tracking area where the WTRU may currently be located.

3GPP TS 23.502 clause 4.12a.2.2 describes that, when a WTRU attempts to register with the 5GC via a TNGF, the AMF may reject the registration attempt and the AMF may provide target TNAN information (SSID, TNGF ID) to the WTRU within the registration reject message indicating the WTRU to build the network access identifier (NAI) based on the TNGF ID. For example, the AMF may determine that the WTRU selected TNGF may not be appropriate for the requested slices that the WTRU may be allowed to access to.

### NF Selection based on Energy Related Information

3GPP TR 23.700-66, V19.0.0 describes enhancements to the 5G system with a goal of improving the energy efficiency of the 5G System. In an enhancement, network function (NF) discovery and (re-)selection may be based on energy related information. NF profiles which may be stored in the network repository function (NRF) may be extended (e.g. to include new energy related information or reuse existing NF profile parameters) to allow an operator to influence NF discovery and selection based on their energy strategy. For example, the user plane path of a PDU session may be adjusted for energy efficiency by considering energy related information when a UPF is (re-)selected to serve the PDU session.

In an example, a WTRU may connect to the 5G system via non-3GPP access. The N3IWF and TNGF may be part of the user plane path of the PDU Session(s) of the WTRU.

In an example, the SMF may perform UPF selection and the SMF may consider energy related information about UPF(s) when performing UPF selection. The SMF may receive the energy related information, for example, from the NRF.

The WTRU may perform N3IWF and/or TNGF selection. The WTRU is not part of the 5G core network (5GC) and may not have access to the NRF or energy related information about the N3IWF(s) and TNGF(s) that can be selected by the WTRU. The 5G system may not allow the WTRU to select an N3IWF/TNGF such that the energy related information may be considered. Selection of the N3IWF/TNGF and UPF may impact the energy consumption that may result from the user plane traffic of a WTRU. Embodiments described herein enable system enhancements allowing the selection of an N3IWF/TNGF based on energy related information.

Embodiments described herein describe how a WTRU may be configured with energy related information that can be used when selecting an N3IWF/TNGF. Embodiments described herein describe how the network can direct the WTRU to perform a new N3WIF/TNGF selection procedure if the N3IWF/TNGF that may have been initially selected is not satisfactory in terms of the energy consumption that may be estimated to result from the initial selection.

A second procedure is described herein. In the second procedure, the WTRU may connect (e.g., directly) to a data plane gateway to send and receive data for a PDU session. The data plane gateway may serve as a security gateway between the WTRU and the network (e.g., the UPF). The second procedure describes how a WTRU can be configured with energy related information that can be used when selecting the data plane gateway and how the network can direct the WTRU to perform a new data plane gateway selection procedure if the data plane gateway that may have been initially selected is not satisfactory in terms of the energy consumption that may be estimated to result from the initial selection.

### N3IWF/TNGF Selection Based on Energy Information

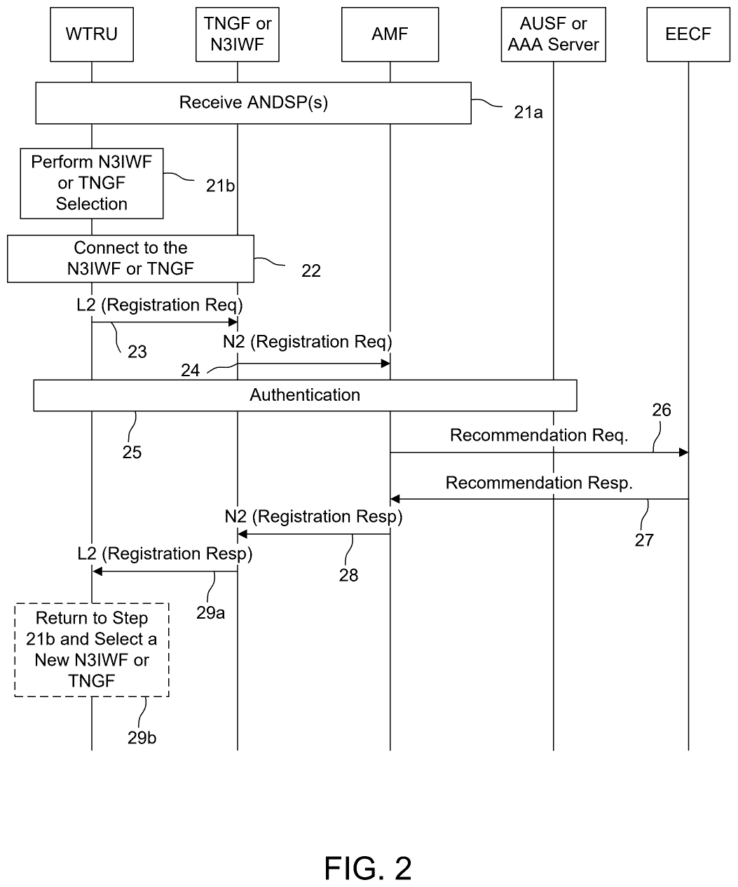

FIG. 2 is a diagram illustrating an example procedure for performing non 3GPP gateway (e.g., N3IWF/TNGF) selection based on energy information. The Example procedure further allows the network to recommend that the WTRU may select (or not select) a different N3IWF or TNGF based on energy information that may be available in the network.

As shown at 21a and 21b, the WTRU may receive (e.g., information indicating) an access network discovery & selection policy (ANDSP). The ANDSP may include energy information that may assist the WTRU in selecting a TNGF/N3IWF. For example, the ANDSP may include the energy-based selection assistance information for a (e.g., each) TNGF identifier/N3IWF identifier. Energy-based selection assistance information may include any of (i) a data network name (DNN), (ii) an S-NSSAI, (iii) location information, and one or more energy metrics.

A WTRU may be capable of connecting (e.g., establishing) multiple PDU sessions. For example, a (e.g., each) PDU session may be associated with a DNN/S-NSSAI combination. The network may select a UPF to anchor the PDU session based on the DNN/S-NSSAI combination that may be associated with the PDU session. For example, the network may consider the WTRU's location when selecting a UPF to anchor the PDU session (e.g., the UPF may be selected based on WTRU location information). For example, the network may (e.g., prefer to) select a UPF that may be geographically closer to the WTRU or network function (e.g., any of N3IWF, RAN node, TNGF) that may anchor the N2 interface that may be associated with the WTRU.

The location information in the energy-based selection assistance information may indicate to the WTRU where the energy-based selection assistance information may be valid. For example, if the WTRU is not in a location overlapping with the location indicated in the location information, the WTRU may determine that the energy-based selection assistance information may not be considered.

An example of how the WTRU may consider the energy-based selection assistance information is described herein. For a (e.g., each) PDU session that the WTRU may anticipate that it may (e.g., need to) establish or may have already established, the WTRU may check (e.g., determine) if the WTRU has received energy-based selection assistance information for the PDU session. For example, the WTRU may check (e.g., determine) if the WTRU has received energy-based selection assistance information for the DNN/S-NSSAI combination that may be associated with the PDU session. If the WTRU has energy-based selection assistance information for the DNN/S-NSSAI combination that may be associated with the PDU session, the WTRU may use the energy metrics to estimate the energy of the PDU session if the associated N3IWF/TNGF is selected by the WTRU and used by the WTRU for the PDU session relative to the energy of the PDU session if a different N3IWF/TNGF is selected by the WTRU and used by the WTRU for the PDU session.

Examples of energy metrics for a N3IWF/TNGF and DNN/S-NSSAI combination are described herein.

A first example of energy metrics includes what percentage of the energy consumed by the N3IWF/TNGF and DNN/S-NSSAI combination may be (e.g., likely) to be related to renewable energy.

A second example of energy metrics includes what percentage of the energy consumed by the N3IWF/TNGF and DNN/S-NSSAI combination may be (e.g., likely) to be related to carbon emissions.

In a third example, a metric may indicate the energy efficiency of the N3IWF/TNGF and DNN/S-NSSAI combination. Examples of energy efficiency calculations described in TS 28.554, “5G end to end Key Performance Indicators (KPI)” V19.0.0. are applicable to embodiments described herein.

For example, the energy efficiency of a N3IWF/TNGF and DNN/S-NSSAI combination may be calculated by dividing the performance of the N3IWF/TNGF and DNN/S-NSSAI combination by the energy consumption of the N3IWF/TNGF and DNN/S-NSSAI combination. The performance of the N3IWF/TNGF and DNN/S-NSSAI combination may be based on the type of slice that may be associated with the N3IWF/TNGF and DNN/S-NSSAI combination.

In another example, the energy efficiency of a N3IWF/TNGF and DNN/S-NSSAI combination may be calculated by dividing the useful output of the N3IWF/TNGF and DNN/S-NSSAI combination by the energy consumption of the N3IWF/TNGF and DNN/S-NSSAI combination. The useful output of the N3IWF/TNGF and DNN/S-NSSAI combination may be based on the amount of data that may be sent via the N3IWF/TNGF and DNN/S-NSSAI combination.

In another example, the energy efficiency of a N3IWF/TNGF and DNN/S-NSSAI combination may be calculated by dividing the (e.g., maximum, upper bound) data rate that may be achievable for the N3IWF/TNGF and DNN/S-NSSAI combination by the energy consumption of the N3IWF/TNGF and DNN/S-NSSAI combination. The (e.g., maximum, upper bound) data rate that may be achievable for the N3IWF/TNGF and DNN/S-NSSAI combination may be known (e.g., determined) based on configuration of the N3IWF/TNGF and DNN/S-NSSAI combination.

The WTRU may use the energy metrics to compare the expected energy consumption, in terms of amount of energy and/or type of energy (e.g., renewable energy and carbon related) and may select a N3IWF/TNGF. For example, the WTRU may select a N3IWF/TNGF that may satisfy an energy consumption condition, as described in any of the following examples.

In a first example, the WTRU may, based on local polices, select the N3IWF/TNGF that may likely result in the lowest energy consumption (e.g., the N3IWF/TNGF and DNN/S-NSSAI combination that may be most energy efficient, the N3IWF/TNGF and DNN/S-NSSAI combination which energy efficiency may be above a threshold).

In a second example, the WTRU may, based on local polices, select the N3IWF or TNGF that may use renewable energy and may likely result in the lowest energy consumption (e.g. the N3IWF/TNGF and DNN/S-NSSAI combination that may be associated with renewable energy and that may be the most energy efficient).

In a third example, the local policies that may determine whether the WTRU may prefer a N3IWF/TNGF that may use renewable energy rather than (e.g., instead of) a N3IWF/TNGF that may use non-renewable energy (e.g., associated with carbon emissions), may be received by the WTRU from the network. The network operator may configure the WTRU to (e.g., preferably) select a N3IWF/TNGF and DNN/S-NSSAI combination that may be associated with renewable energy and/or that may be most efficient.

The local policies that may determine whether the WTRU may prefer a N3IWF/TNGF using renewable energy rather than (e.g., instead of) a N3IWF/TNGF using non-renewable energy (e.g., associated with carbon emissions) may be received by the mobile termination (MT) part of the WTRU from the terminal equipment (TE) part of the WTRU. For example, an application with a graphical user interface (GUI) that may run in the TE part of the WTRU may allow the user of the WTRU to configure the WTRU to (e.g., preferably) select a N3IWF/TNGF and DNN/S-NSSAI combination that may be associated with renewable energy and/or that may be more (e.g., most) efficient.

As shown at 22, the WTRU may select a SSID based on the selected the N3IWF/TNGF, may connect to the non-3GPP network that may be associated with the SSID, and may establish a layer two (L2) connection with the selected TNGF/N3IWF.

As shown at 23, the WTRU may send a (e.g., first request) message to the TNGF/N3IWF. The (e.g., first request) message may include a registration request message for the AMF.

As shown at 24, the N3IWF/TNGF may send the registration request message and (e.g., that may include) WTRU location information to the AMF. The N2 interface may be used by the N3IWF/TNGF to send the registration request message e.g., including the WTRU location information to the AMF. The WTRU location information that may be sent by the N3IWF/TNGF may include location information that may have been received from an access point (e.g., a trusted non 3GPP access point (TNAP)). The location information may include an SSID that the WTRU may be connected to. The location information may include geographical data that may be received from the WTRU.

As shown at 25, the AMF, the access authentication and authorization (AAA) server, and the WTRU may participate in an authentication procedure.

As shown at 26, the AMF may send information (e.g., in a recommendation request) to the energy efficiency control function (EECF) about the registration request of the WTRU. The recommendation request may include (e.g., indicate) any of the slices that may be requested by the WTRU (e.g., the request NSSAI that may have been included in the registration request), the identity of the TNGF/N3IWF that the WTRU may be attempting to use to connect to the AMF, and the WTRU location information.

In an example, (e.g., instead of sending the WTRU's requested slices (S-NSSAI(s)) to the EECF), the AMF may (e.g., choose to) send a list of slices (S-NSSAI(s)) that the WTRU may be allowed to use to the EECF.

As shown at 27, the EECF may reply to AMF with (e.g., by sending a recommendation response including) any of the following information: (i) a list of N3IWF(s) that the WTRU may be recommended to use, (ii) a list of TNGF(s) that the WTRU may be recommended to use, (iii) a list of N3IWF(s) that the WTRU may NOT be recommended to use, (iv) a list of TNGF(s) that the WTRU may NOT be recommended to use, (v) an indication that the WTRU may not (e.g., need to) connect via a different TNGF/N3IWF, and (vi) an indication that the WTRU may (e.g., be requested to) connect via a different TNGF/N3IWF.

The EECF may determine the lists based on the current energy consumption of the network slices that the WTRU may request to register to or the network slices that the WTRU may be allowed to use.

The EECF may determine the lists based on any of the WTRU location information and the energy cost that may (e.g., likely) result from the WTRU registering to the network slices from the WTRU current location. For example, the EECF may recommend that the WTRU may connect via an N3IWF/TNGF that may (e.g., likely) result in lower energy consumption. For example, the EECF may recommend that the WTRU may NOT connect via an N3IWF/TNGF that may (e.g., likely) result in higher energy consumption.

The EECF may (e.g., determine to) send to the AMF an indication that the WTRU may not (e.g., need to) connect via a different TNGF/N3IWF based on the estimated energy consumption incurred by the WTRU connecting via the TNGF/N3IWF being sufficiently low (e.g., satisfying an energy condition).

The EECF may (e.g., determine to) send to the AMF an indication that the WTRU may (e.g., need to) connect via a different TNGF/N3IWF based on the estimated energy consumption incurred by the WTRU connecting via the TNGF/N3IWF being too high (e.g., failing to satisfy an energy condition). The inclusion of a list of TNGF(s)/N3IWF(s) that the WTRU may be recommended to use may be an indication that the WTRU may (e.g., need, be requested) to connect via a different TNGF/N3IWF. The inclusion of a list of TNGF(s)/N3IWF(s) that the WTRU may not be recommended to use, which may include the TNGF/N3IWF that the WTRU may currently be using, may be an indication that the WTRU may (e.g., need, be requested) to connect via a different TNGF/N3IWF.

As shown at 28, the AMF may send a registration accept or registration reject message for the WTRU. The registration accept/reject message may be sent to the N3IWF/TNGF via the N2 interface.

As shown at 29a, the registration accept message or registration reject message may be received by the WTRU.

If the EECF indicated that the WTRU may be recommended to change the TNGF/N3IWF that the WTRU may currently be using to connect or if the EECF indicated that the WTRU may not (e.g., need to) connect via a different TNGF/N3IWF, the AMF may (e.g., determine to) send a registration accept message to the WTRU. The registration accept message may include any of the list of N3IWF(s) that the WTRU may be recommended to use, the list of TNGF(s) that the WTRU may be recommended to use, the list of N3IWF(s) that the WTRU may NOT be recommended to use, and the list of TNGF(s) that the WTRU may NOT be recommended to use. The WTRU may use any of the lists when performing a future N3IWF/TNGF selection procedure. For example, the WTRU may (e.g., determine to) perform a N3IWF/TNGF selection procedure when connecting to a different SSID or when determining that the N3IWF/TNGF that it may currently be connected to may no longer be available. For example, receiving a registration accept message may not trigger the WTRU to perform a N3IWF/TNGF reselection procedure.

If the EECF indicated that the WTRU may not be recommended to change the TNGF/N3IWF that the WTRU may currently be using to connect or if the EECF indicated that the WTRU may (e.g., need to) connect via a different TNGF/N3IWF, the AMF may (e.g., determine to) send a registration reject message to the WTRU. The registration reject message may include any of the list of N3IWF(s) that the WTRU may be recommended to use, the list of TNGF(s) that the WTRU may be recommended to use, the list of N3IWF(s) that the WTRU may NOT be recommended to use, and the list of TNGF(s) that the WTRU may NOT be recommended to use. Reception of the registration reject message may trigger the WTRU to perform a new N3IWF/TNGF selection procedure. As shown at 29b, after the WTRU may have selected a new TNGF/N3IWF, the WTRU repeat the operations shown at 22 with the newly selected N3IWF/TNGF. For example, this procedure may be repeated with the new N3IWF/TNGF. For the new N3IWF/TNGF selection (e.g., reselection) procedure, the WTRU may (e.g., only) consider the N3IWF(s)/TNGF(s) that may have been recommended to use and may not consider the N3IWF(s)/TNGF(s) that may not have been recommended to use. The new N3IWF(s)/TNGF(s) may be selected from the N3IWF(s)/TNGF(s) that may have been recommended to use, excluding the N3IWF(s)/TNGF(s) that may may not have been recommended to use.

Providing the WTRU with a list of N3IWF(s)/TNGF(s) that may not be recommended to use may allow the network to recommend to the WTRU to avoid using N3IWF(s)/TNGF(s) that may currently be associated with high energy usage or carbon emissions e.g., without needing to send a new set of WLAN selection policies (WLANSPs) to the WTRU.

In an example, for a (e.g., each) list of N3IWF(s)/TNGF(s) that the WTRU may be recommended to use or to not use, the AMF may (e.g., also) send a list validity timer value to the WTRU. The list validity timer value may be based on information that may have been received from the EECF. The list validity timer value may indicate to the WTRU how long the list may be considered valid. The timer value may be useful in situations where the EECF may have anticipated that particular N3IWF(s)/TNGF(s) may (e.g., likely) to be associated with high energy consumption (e.g., only) for a period of time or if the EECF may not predict the energy consumption of the N3IWF(s)/TNGF(s) with high (e.g., sufficient) confidence beyond a (e.g., certain) time period. In another example, the EECF may provide a separate validity time recommendation for a (e.g., each) N3IWF/TNGF and the AMF may provide separate validity times (e.g., one per N3IWF/TNGF) to the WTRU in the registration accept/reject message. The WTRU may use the validity time information to determine when the recommendations may be discarded and/or no longer considered.

In another example, if the EECF indicated that the WTRU may not be recommended to change the TNGF/N3IWF that the WTRU may currently be using to connect or if the EECF indicated that the WTRU may (e.g., need, be requested) to connect via a different TNGF/N3IWF, the AMF may (e.g., determine to) send a registration accept message to the WTRU and may request the policy control function (PCF) to send updated policies to the WTRU. The updated policies may include any of the list of N3IWF(s) that the WTRU may be recommended to use, the list of TNGF(s) that the WTRU may be recommended to use, the list of N3IWF(s) that the WTRU may NOT be recommended to use, and the list of TNGF(s) that the WTRU may NOT be recommended to use. The AMF may subscribe to be notified by the PCF after (e.g., once) the updated policies may have been sent to the WTRU. After (e.g., once) the updated policies may have been sent to the WTRU, the network may send a registration reject message to the WTRU. The registration reject message may trigger the WTRU to start a new N3IWF/TNGF selection procedure based on the updated policies.

The procedure illustrated at FIG. 2 shows how a WTRU can be configured with policies that may be used to select an N3IWF/TNGF that may serve the WTRU's connection and may reduce (e.g., minimize) energy consumption. The procedure illustrated at FIG. 2 shows how the network can redirect the WTRU to a different N3IWF/TNGF in case the network has determined, based on information that may (e.g., only) be available to the network (e.g., analytics from the NWDAF and/or EECF) that using a different /IWF/ TNGF for serving the WTRU may improve the network performance.

### Selection of a Data Plane Gateway Based on Energy Information

In an example, for a (e.g., each) PDU session that the WTRU may have established, the WTRU may connect to a UPF via a connection between the WTRU and a data plane gateway that may be associated with the UPF. The data plane gateway may terminate an IP tunnel that may be between the WTRU and the data plane gateway. The tunnel may be used to send data from the PDU session between the WTRU and the data plane gateway. The data plane tunnel may send and receive data of the PDU session to and from the UPF. The data plane gateway may serve as a security gateway between the WTRU and the network (e.g., the UPF).

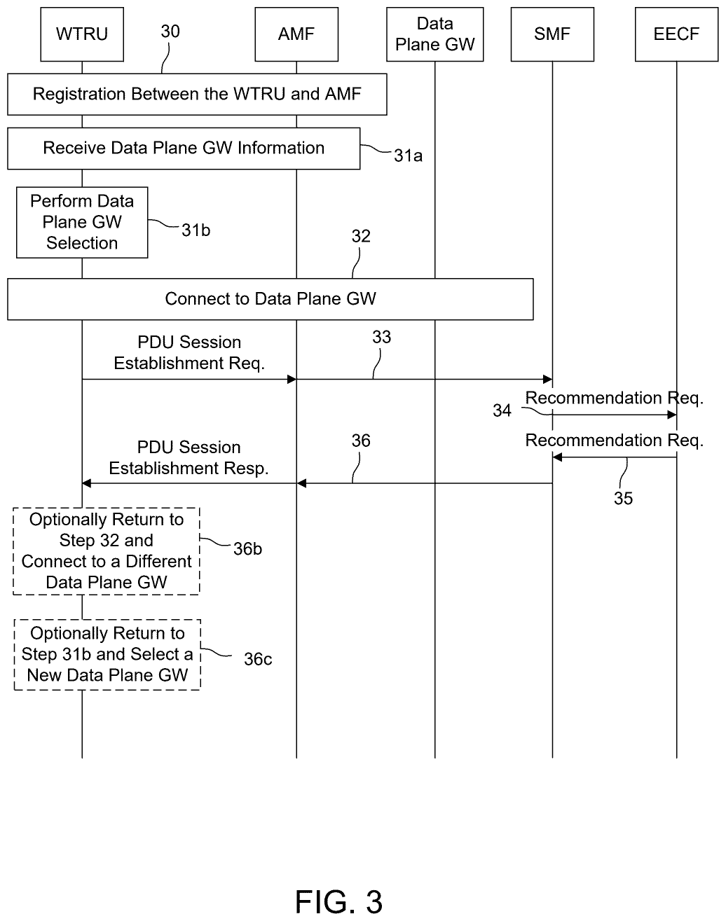

FIG. 3 is a diagram illustrating an example procedure for a WTRU to perform data plane gateway selection based on energy information. The example procedure may allow the network to recommend the WTRU to select (or to not select) a different data plane gateway based on energy information that may be available in the network.

As shown at 30, the WTRU may perform a registration procedure with the network (e.g., the AMF).

As shown at 31a, the WTRU may receive a data plane gateway selection information. The data plane gateway selection information may include energy information that may assist the WTRU in selecting a data plane gateway. For example, the data plane gateway selection information may include the energy-based selection assistance information for a (e.g., each) data plane gateway (e.g., identifier). As described herein in relation to FIG. 2, energy-based selection assistance information may include any of (i) a DNN, (ii) an S-NSSAI, (iii) location information, and one or more energy metrics.

An example of how the WTRU may can consider (e.g., use) the energy-based selection assistance information is described herein. The WTRU may check (e.g., determine) if the WTRU has received energy-based selection assistance information for the DNN/S-NSSAI combination that the WTRU may expect to associate with a PDU session. If energy-based selection assistance information is available to the WTRU for the DNN/S-NSSAI combination that may be associated with the PDU session, the WTRU may use the energy metrics to estimate the energy of the PDU session if the associated data plane gateway is selected and used by the WTRU for the PDU session relative to the energy of the PDU session if a different data plane gateway is selected and used by the WTRU for the PDU session.

The WTRU may use the energy metrics to compare the expected energy consumption, in terms of amount of energy and/or type of energy (e.g., renewable energy and carbon related) and select a data plane gateway as shown at 31b.

As shown at 32, the WTRU may perform a connection procedure with the data plane gateway (e.g., the WTRU may connect to the data plane gateway). The connection procedure may involve establishing a secure tunnel between the WTRU and the data plane gateway.

As shown at 33, the WTRU may send a PDU session establishment request message to the network. The PDU session establishment request message may be received by an SMF (e.g., via an AMF). The PDU session establishment request message may include, for example, the DNN/S-NSSAI combination to be associated with the PDU session. In an example, the PDU session establishment request message may be associated with the selected data plane gateway. The PDU session establishment request may include, for example, the identity of the selected data plane gateway.

As shown at 34, the SMF may send a (e.g., recommendation) request to the EECF. The (e.g., recommendation) request may include information about the PDU session that the WTRU may be attempting to establish. The (e.g., recommendation) request may include any of a request to recommend a UPF to serve the PDU session and a request to check if a different data plane gateway may be (e.g., more appropriate to be) used for the PDU session. The (e.g., recommendation) request message may include any of (i) the DNN/S-NSSAI combination that may have been received from the AMF and may be associated with the PDU session, (ii) the WTRU identity, (iii) WTRU location information that may have been received from the AMF, and (iv) the identity of the data plane gateway that may have been selected by the WTRU and received by the SMF from the WTRU.

As shown at 35, the EECF may reply to the SMF e.g., by sending a (e.g., recommendation response) including any of (i) a data plane gateway identifier recommendation, and (ii) a UPF identifier recommendation.

In an example, the EECF may determine the data plane gateway identifier and UPF identifier based on the current energy consumption of the network slice of the PDU session.

In an example, the EECF may determine the data plane gateway identifier and UPF identifier based on the WTRU location information and the energy cost that may (e.g., likely) result from connecting to the network slice from the WTRU current location. For example, the EECF may recommend that the WTRU may connect via a data plane gateway that may (e.g., likely) result in lower energy consumption based on the data plane gateway being geographically closer to the WTRU.

In an example, the EECF may determine to send to the SMF an indication that the WTRU may not (e.g., need to) connect via a different data plane gateway based on the estimated energy consumption that may be incurred by the WTRU connecting via the data plane gateway that the WTRU may already be connected to being sufficiently low (e.g., satisfying an energy condition).

In an example, the EECF may determine to send to the SMF an indication that the WTRU may (e.g., need to) connect via a different data plane gateway based on the estimated energy consumption that may be incurred by the WTRU connecting via the data plane gateway being too high (e.g., failing to satisfy an energy condition). The inclusion of a data plane gateway identifier that the WTRU may be recommended to use may be an indication that the WTRU may (e.g., need, be requested) to connect via a different data plane gateway.

The operation performed by the EECF and the message/information exchange between the EECF and other network elements described in relation to FIG. 2 (e.g., for N3IWF/TNGF energy-based selection) may also be applicable to the EECF operation and message/information exchange described in relation to FIG. 3 (e.g., for data plane gateway selection). For example, the EECF may include one or more data plane gateway identifiers to not be used for a data plane gateway reselection.

As shown at 36, the SMF may send a PDU session establishment accept message to the WTRU and may configure the UPF that may be associated with the UPF identifier to be the PSA of the PDU session.

In an example, the PDU session establishment accept message may include an identity of a data plane gateway which, as shown at 36b, may trigger the WTRU to disconnect from the data plane gateway that may have been identified (e.g. indicated) in the PDU session establishment request message as shown at 33, and to connect to the data plane gateway that may have been identified (e.g., indicated) in the PDU session establishment accept message as shown at 66.

In another example, the PDU session establishment accept message may include an indication that the WTRU may select a new data plane gateway which, as shown at 36c, may trigger the WTRU to disconnect from the data plane gateway that may have been identified (e.g. indicated) in the PDU session establishment request message as shown at 33, and to repeat the procedure shown at 31b to select a new data plane gateway. When the WTRU repeats the procedure shown at 31b, the WTRU may not consider the data plane gateway that may have been identified (e.g., indicated) the PDU session establishment request message as shown at 33 (e.g., the previously selected data plane gateway). For example, if the PDU session establishment accept message indicates one or more data place gateway identifiers to not use in a data plane gateway reselection, the WTRU may ignore (e.g., not use in the reselection) the indicated one or more data place gateway identifiers.

When the WTRU connects to a new data plane gateway, the WTRU may send a PDU session modification request message and the PDU session modification request message may include the identity of the new data plane gateway.

### Re-Selection of a Data Plane Gateway Based on Energy Information

In an example, the SMF may determine that a different UPF may be to be used to serve a PDU session. The SMF may send a request to the EECF to receive a recommendation for what data plane gateway (or N3IWF/TNGF) may serve the PDU session. The EECF may provide a data plane gateway identifier to the SMF, e.g., in a recommendation response message.

Reception of the data plane gateway identifier from the EECF may trigger the SMF to (i) send a PDU session modification command message to the WTRU including the data plane gateway identifier, or (ii) send a PDU session release message to the WTRU including any of the data plane gateway identifier and rejection cause code that may indicate that the WTRU may re-establish the PDU session.

If the WTRU receives a data plane gateway identifier from the SMF, the WTRU may be triggered to connect to the data plane gateway.

If the WTRU receives a rejection cause code indicating that the WTRU may re-establish the PDU session, the WTRU may re-establish the PDU session and use the data plane gateway.

### Example Methods for Non-3GPP Data Plane Configuration Based on Energy Information

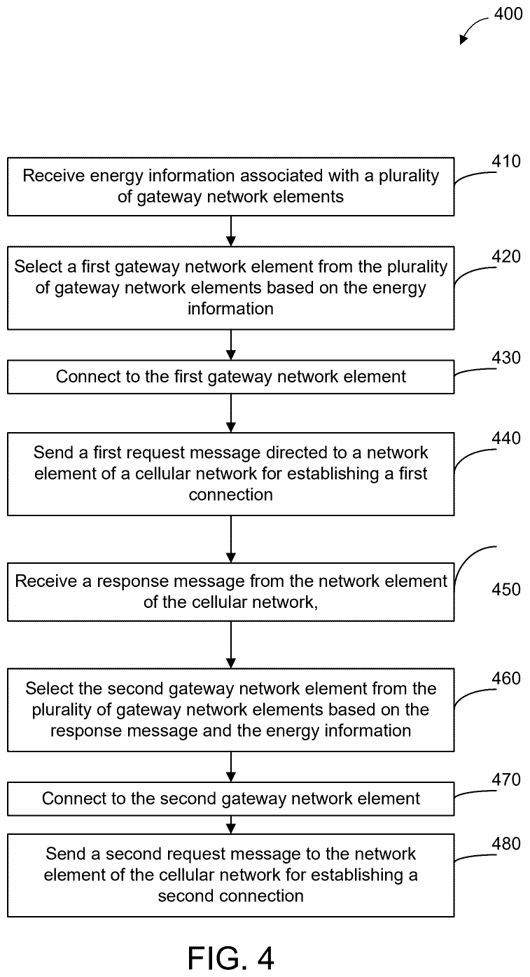

FIG. 4 is a diagram illustrating an example method 400 for non-3GPP data plane configuration based on energy information. The method 400 may be implemented in a WTRU. The WTRU may include circuitry including any of transmitter, a receiver, a processor, and a memory. The circuitry may be configured to carry out the method 400. As shown at 410, the method 400 may include receiving energy information associated with a plurality of gateway network elements. As shown at 420, the method 400 may include selecting a first gateway network element from the plurality of gateway network elements based on the energy information. As shown at 430, the method 400 may include connecting to the first gateway network element. As shown at 440, the method 400 may include sending a first request message directed to a network element of a cellular network for establishing a first connection. In various embodiments, the first request message may be associated with the first gateway network element. As shown at 450, the method 400 may include receiving a response message from the network element of the cellular network. In various embodiments, the response message may indicate that a second gateway network element may be to be selected by the WTRU from the plurality of gateway network elements. In various embodiments, the response message may further indicate one or more gateway network elements of the plurality of gateway network elements to not be used for selecting the second gateway network element. As shown at 460, the method 400 may include selecting the second gateway network element from the plurality of gateway network elements based on the response message and the energy information. As shown at 470, the method 400 may include connecting to the second gateway network element. As shown at 480, the method 400 may include sending a second request message to the network element of the cellular network for establishing a second connection.

In various embodiments, the energy information may comprise one or more energy metrics associated with each gateway network element of the plurality of gateway network elements.

In various embodiments, the energy information may comprise any of a data network name, network slice information and location information.

In various embodiments, the energy information may be received in an access network discovery and selection policy message.

In various embodiments, the first request message being associated with the first gateway network element may comprise sending the first request message to the network element of the cellular network via the first gateway network element.

In various embodiments, sending the first request message may comprise sending a first registration request message to an AMF network element via the first gateway network element.

In various embodiments, receiving the response message may comprise receiving a registration reject message from the AMF network element via the first gateway network element.

In various embodiments, sending the second request message may comprise sending a second registration request message to the AMF network element via the first gateway network element.

In various embodiments, establishing the first connection and the second connection may comprise establishing a first NAS connection and a second NAS connection with the AMF network element.

In various embodiments, the plurality of gateway network elements may comprise a plurality of any of N3IWFs and TNGFs.

In various embodiments, the first request message being associated with the first gateway network element may comprise the first request message indicating an identity of the first gateway network element.

In various embodiments, sending the first request message may comprise sending a first PDU session establishment request message to an SMF network element e.g., via an AMF network element.

In various embodiments, receiving the response message may comprise receiving a PDU session establishment accept message from the SMF network element e.g., via the AMF network element.

In various embodiments, sending the second request message may comprise sending a second PDU session establishment request message to the SMF network element e.g., via the AMF network element.

In various embodiments, establishing the first connection and the second connection may comprise establishing a first PDU session and a second PDU session with respectively a first UPF network element and a second UPF network element.

In various embodiments, the plurality of gateway network elements may comprise a plurality of data plane gateway network elements.

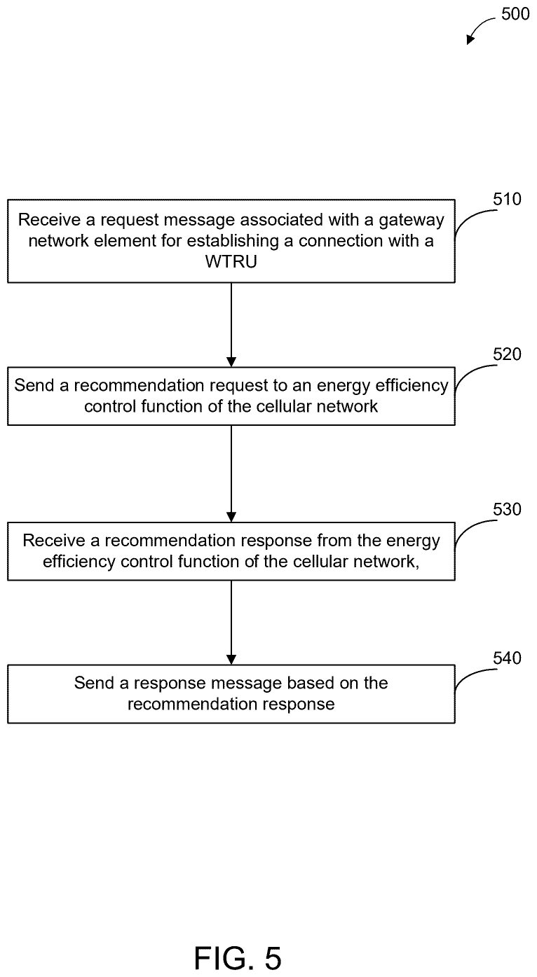

FIG. 5 is a diagram illustrating an example method 500 for non-3GPP data plane configuration based on energy information. The method 500 may be implemented in a network element of a cellular network. The network element may include circuitry including any of transmitter, a receiver, a processor, and a memory. The circuitry may be configured to carry out the method 400. As shown at 510, the method 500 may include receiving a request message associated with a gateway network element for establishing a connection with a WTRU. In various embodiments, the request message may include requested network slice information. As shown at 520, the method 500 may include sending a recommendation request to an EECF of the cellular network. In various embodiments, the recommendation request may comprise the requested network slice information and identity information indicating an identity of the gateway network element. As shown at 530, the method 500 may include receiving a recommendation response from the EECF of the cellular network. In various embodiments, the recommendation response may indicate one or more gateway network elements to not be used in a gateway network element reselection. As shown at 540, the method 500 may include sending a response message based on the recommendation response. In various embodiments, the response message may indicate that a selection of another gateway network element may be to be performed by the WTRU.

In various embodiments, the response message may further indicate the one or more gateway network elements to not be used in the gateway network element reselection.

In various embodiments, receiving the request message associated with the gateway network element may comprise receiving the request message from WTRU via the gateway network element.

In various embodiments, receiving the request message associated with the gateway network element may comprise receiving a registration request message from the WTRU via the gateway network element.

In various embodiments, sending the response message may comprise sending a registration reject message to the WTRU via the gateway network element.

In various embodiments, establishing the connection with the WTRU may comprise establishing a NAS connection between the WTRU and an AMF network element.

In various embodiments, the one or more gateway network elements and the gateway network element may comprise any of N3IWFs and TNGFs.

In various embodiments, the network element may be an AMF network element.

In various embodiments, the request message being associated with the gateway network element may comprise the request message indicating an identity of the gateway network element.

In various embodiments, receiving the request message associated with the gateway network element may comprise receiving a PDU session establishment request message from the WTRU e.g., via an AMF network element.

In various embodiments, sending the response message may comprise sending a PDU session establishment accept message to the WTRU e.g., via the AMF network element.

In various embodiments, establishing the connection with the WTRU may comprise establishing a PDU session between the WTRU and a UPF network element.

In various embodiments, the one or more gateway network elements and the gateway network element may comprise a plurality of data plane gateway network elements.

In various embodiments, the network element may be an SMF network element.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶ 6 or means-plus-function claim format, and any claim without the terms “means for”is not so intended.

The content of each of the following references is incorporated by reference herein in its entirety:
TS 23.501, System architecture for the 5G System (5GS); Stage 2; V19.0.0
TS 24.526, User Equipment (UE) policies for 5G System (5GS); Stage 3; V18.6.0
TS 23.402, Architecture enhancements for non-3GPP accesses; V18.3.0
TS 23.502, Procedures for the 5G System (5GS); Stage 2; V18.6.0
TR 23.700-66, Study on Energy Efficiency and Energy Saving; V19.0.0
TS 28.554, 5G end to end Key Performance Indicators (KPI); V19.0.0

1. A wireless transmit/receive unit (WTRU) comprising circuitry, including any of a transmitter, a receiver, a processor, and a memory, configured to:
receive energy information associated with a plurality of gateway network elements;
select a first gateway network element from the plurality of gateway network elements based on the energy information;
connect to the first gateway network element;
send a first request message directed to a network element of a cellular network for establishing a first connection, wherein the first request message is associated with the first gateway network element;
receive a response message from the network element of the cellular network, wherein the response message indicates that a second gateway network element is to be selected by the WTRU from the plurality of gateway network elements, and wherein the response message further indicates one or more gateway network elements of the plurality of gateway network elements to not be used for selecting the second gateway network element;
select the second gateway network element from the plurality of gateway network elements based on the response message and the energy information;
connect to the second gateway network element; and
send a second request message to the network element of the cellular network for establishing a second connection.

2. The WTRU of claim 1, wherein the energy information comprises one or more energy metrics associated with each gateway network element of the plurality of gateway network elements.

3. The WTRU of claim 1, wherein the energy information comprises any of a data network name, network slice information and location information.

4. The WTRU of claim 1, wherein the energy information is received in an access network discovery and selection policy message.

5. The WTRU of claim 1, wherein the first request message being associated with the first gateway network element comprises sending the first request message to the network element of the cellular network via the first gateway network element.

6. The WTRU of claim 1, wherein the WTRU being configured to send the first request message comprises the WTRU being configured to send a first registration request message to an access and mobility management function (AMF) network element via the first gateway network element.

7. The WTRU of claim 1, wherein the WTRU being configured to receive the response message comprises the WTRU being configured to receive a registration reject message from the AMF network element via the first gateway network element.

8. The WTRU claim 1, wherein the WTRU being configured to send the second request message comprises the WTRU being configured to send a second registration request message to the AMF network element via the first gateway network element.

9. The WTRU of claim 1, wherein establishing the first connection and the second connection comprises establishing a first non-access stratum (NAS) connection and a second NAS connection with the AMF network element.

10. The WTRU of claim 1, wherein the plurality of gateway network elements comprises a plurality of any of non 3GPP interworking functions (N3IWFs) and trusted non-3GPP gateway functions (TNGFs).

11. The WTRU of claim 1, wherein the first request message being associated with the first gateway network element comprises the first request message indicating an identity of the first gateway network element.

12. The WTRU of claim 11, wherein the WTRU being configured to send the first request message comprises the WTRU being configured to send a first protocol data unit (PDU) session establishment request message to a session management function (SMF) network element via an AMF network element.

13. The WTRU of claim 11, wherein the WTRU being configured to receive the response message comprises the WTRU being configured to receive a PDU session establishment accept message from the SMF network element via the AMF network element.

14. The WTRU of claim 11, wherein the WTRU being configured to send the second request message comprises the WTRU being configured to send a second PDU session establishment request message to the SMF network element via the AMF network element.

15. The WTRU of claim 11, wherein establishing the first connection and the second connection comprises establishing a first PDU session and a second PDU session with respectively a first user plane function (UPF) network element and a second UPF network element.

16. The WTRU of claim 11, wherein the plurality of gateway network elements comprises a plurality of data plane gateway network elements.

17. A method, implemented in a wireless transmit/receive unit (WTRU), the method comprising:
receiving energy information associated with a plurality of gateway network elements;
selecting a first gateway network element from the plurality of gateway network elements based on the energy information;
connecting to the first gateway network element;
sending a first request message directed to a network element of a cellular network for establishing a first connection, wherein the first request message is associated with the first gateway network element;
receiving a response message from the network element of the cellular network, wherein the response message indicates that a second gateway network element is to be selected by the WTRU from the plurality of gateway network elements, and wherein the response message further indicates one or more gateway network elements of the plurality of gateway network element to not be used for selecting the second gateway network element;
selecting the second gateway network element from the plurality of gateway network elements based on the response message and the energy information;
connecting to the second gateway network element; and
sending a second request message to the network element of the cellular network for establishing a second connection.

18. A method implemented in a network element of a cellular network, the method comprising:
receiving a request message associated with a gateway network element for establishing a connection with a wireless transmit/receive unit (WTRU), wherein the request message includes requested network slice information;
sending a recommendation request to an energy efficiency control function of the cellular network, wherein the recommendation request comprises the requested network slice information and identity information indicating an identity of the gateway network element;
receiving a recommendation response from the energy efficiency control function of the cellular network, wherein the recommendation response indicates one or more gateway network elements to not be used in a gateway network element reselection; and
sending a response message based on the recommendation response, wherein the response message indicates that a selection of another gateway network element is to be performed by the WTRU.

19. The method of claim 18, wherein the response message further indicates the one or more gateway network elements to not be used in the gateway network element reselection.

20. The method of claim 18, wherein receiving the request message associated with the gateway network element comprises receiving the request message from WTRU via the gateway network element.
